(19) United States
(12) Patent Application Publication
(10) Pub. No.: US 2026/0111842 A1
(43) Pub. Date: Apr. 23, 2026

(54) METHOD AND APPARATUS FOR IMPLEMENTING ADVANCED TRACK AND TRACE FUNCTIONS USING UNIQUE PRODUCT CODE LABELING

(71) Applicant: Metrc ID, LLC, Lakeland, FL (US)

(72) Inventors: Michael D. Johnson, Lakeland, FL (US); James D. Daley, Lakeland, FL (US); David P. Eagleson, Lakeland, FL (US)

(21) Appl. No.: 19/365,652

(22) Filed: Oct. 22, 2025

Related U.S. Application Data
(60) Provisional application No. 63/711,039, filed on Oct. 23, 2024.

(51) Int. Cl. G06Q 10/087; G06K 19/06; G06Q 20/20; G06Q 30/018

(52) U.S. Cl. CPC G06Q 10/08772; G06K 19/06037; G06Q 20/203; G06Q 20/208; G06Q 30/0185

(57) ABSTRACT

An electronically readable identification system to create unique, machine readable codes that can be associated with each product of a batch and can be used for labeling products. The codes may be QR codes or other printable codes which are electronically readable and which allow the user to create millions of unique electronically readable codes, print or store them on compliant product labels, and encode them with data for supply chain partners as well as consumers. A centralized database having records for each individual unit of a product that allows for control of the reading and writing of data for that database of the information for each product. The system can be used to track the provenance of each individual product unit. Various applications include regulated products, such fruits, vegetables, dairy, meat, cannabis, goods, and services. An API system for controlling and providing access to information in the database.

### CLAIM OF PRIORITY

This application claims the benefit of priority to U.S. Provisional Patent Application Ser. No. 63/711,039, filed on Oct. 23, 2024, which is incorporated by reference herein in its entirety.

### TECHNICAL FIELD

The present disclosure pertains to methods and apparatus for a track and trace system for products, and more particularly to methods and apparatus for a product identification system providing unique identifier for each unit of a product.

### BACKGROUND

Product identification systems involve methods and apparatus for labeling products with unique identifiers. These systems enable tracking and tracing of products throughout the supply chain. They often utilize electronically readable codes, such as barcodes or QR codes, to provide information about individual product units. Applications include inventory management, product authentication, and supply chain transparency.

In product identification systems, the primary goal is to ensure accurate tracking of products from manufacturing to the end consumer. This involves assigning identifiers to each product unit, which can be scanned and recorded at various points in the supply chain. The system aims to enhance inventory management, streamline logistics, and improve product traceability.

Another goal is to facilitate efficient inventory management. By using identifiers, businesses can automate the tracking of product quantities, locations, and movements. This reduces manual errors and enhances the accuracy of inventory records. The system also supports real-time updates, allowing businesses to respond quickly to changes in demand or supply chain disruptions.

Ensuring product authenticity and preventing counterfeiting is a significant supply chain challenge. Identifiers help verify the origin and authenticity of products, protecting both consumers and brands.

It is known from prior art that traditional product labeling systems often rely on static group identifiers, such as SKUs or barcodes, which do not provide detailed information about individual product units. These systems may not support real-time updates or integration with modern supply chain technologies. They lack the ability to track individual product units uniquely, limiting their effectiveness in preventing counterfeiting and ensuring product authenticity.

There is thus a need for a more advanced product identification system that provides unique identifiers for each product unit, supports real-time updates, and integrates seamlessly with supply chain technologies. Such a system should enhance inventory management, improve product traceability, and offer robust protection against counterfeiting.

### SUMMARY

The present subject matter provides, among other things, a track and trace system combined with a protocol for creating product labels and tracking barcodes across multiple vendors within a supply chain. In various embodiments the present subject matter provides a continuous or nearly continuous updatable controlled database affording various participants in the supply chain to update or investigate a number of parameters associated with product quality, production, and/or status. In various embodiments, such information may be tracked and monitored on a unit basis for any given product using an electronically readable code. In various embodiments the electronically readable code is a bar code. In various embodiments the electronically readable code is a QR code. In various embodiments the electronically readable code is a wirelessly readable code. Those of skill in the art will appreciate that other codes may be used, and may be used in various combinations and subcombinations, without departing from the scope of the present subject matter.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

1The drawings illustrate generally, by way of example, various embodiments of the present subject matter discussed in the present document.

FIG. 1A is a block diagram of various functional modules of a retail identification system having a serialized product database that exchanges information using an application programming interface (API) for software by various partners in the track and trace process and point of sale (POS) systems, according to one embodiment of the present subject matter.

FIG. 1B is a block diagram of various functional modules of a retail identification system having a serialized product database that exchanges information using a software development kit (SDK) for software by various partners in the track and trace process and point of sale (POS) systems, according to one embodiment of the present subject matter.

FIG. 2 shows an exemplary labeling schema used in various embodiments of the present methods and apparatus.

FIG. 3 is a block diagram of various participants in the labeling system according to one embodiment of the present subject matter.

FIG. 4 illustrates an example embodiment of a method for printing labels for products on a per unit basis, according to one embodiment of the present subject matter.

FIG. 5 demonstrates an association of codes to packages, according to one embodiment of the present subject matter.

FIG. 6 is a flow chart of label generation for “deli” style product sales, according to one embodiment of the present subject matter.

FIG. 7 demonstrates package handling and labelling using unique codes and the serialized product database, according to one embodiment of the present subject matter.

FIG. 8 demonstrates a process of merging two packages using unique codes and the serialized product database, according to one embodiment of the present subject matter.

FIG. 9 demonstrates a process for administrative holds and recalls of product using unique codes and the serialized product database, according to one embodiment of the present subject matter.

FIGS. 10-11 demonstrate a mobile inspection application that can be used during inspections using unique codes and the serialized product database, according to one embodiment of the present subject matter.

FIG. 12 is a block diagram of a machine in the example form of a computing system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

In various embodiments, the present subject matter provides, among other things, advanced track and trace features and methods for creating product labels and tracking barcodes across multiple vendors within a supply chain. The present subject matter includes a continuously or periodically updatable database affording various partners in the supply chain to update and/or investigate a number of parameters associated with product quality, production, and/or status. Such information may be tracked and monitored on a per-unit basis for any given product using a unique, assigned electronically readable code. In various embodiments the electronically readable code is a bar code. In various embodiments the electronically readable code is a QR code. In various embodiments the electronically readable code is a wirelessly readable code.

Some exemplary codes and labeling methods and apparatus are described in U.S. Provisional Application, Ser. No. 63/583,637, filed Sep. 19, 2023, Method and Apparatus for Electronically Readable Product Code Labeling System, now U.S. application Ser. No. 18/887,303, filed on Sep. 17, 2024, each of which is commonly assigned to the applicant of this application, and each of which is incorporated by reference in its entirety. Those of skill in the art will appreciate that other codes may be used, and may be used in various combinations and subcombinations, without departing from the scope of the present subject matter. The examples provided in this disclosure shall reference a QR code as an example, but the disclosure is not limited to QR codes and may include other codes.

As set forth in U.S. Ser. No. 63/583,637, various functional modules of a labeling system, including the following components:
a. A mobile point of sale software application (“mobile app”) that allows users to scan an electronically readable code, such as a bar code, QR code, or other wirelessly readable code to access supply chain provenance information and verify product safety.
b. A web administration interface that manages supply chain data, product data, and customer data.
c. A label templating system that synchronizes compliance data with print or other visual depiction systems.
d. A product database 108, which associates each unit of a product with a unique electronically readable code, such as a bar code, QR code, or other wirelessly readable code and supply chain provenance information for each product unit.

These different components can be located on a single device, multiple devices in one location, or multiple objects in various locations. A network 110 may be used to interconnect any two or more of these modules. In the case of remote devices, the network 110 may be a local area network (LAN), the INTERNET, a personal area network, a wireless network, other networks, or any combination of these networks.

The present subject matter is designed to increase supply chain efficiency and safety. The present system may be applied in a variety of different businesses and applications. One such deployment is in the cannabis retail business. It is understood that cannabis production, distribution and retail is only one application of the present subject matter and that the present subject matter can be deployed in other markets and industries without departing from the scope of the present subject matter.

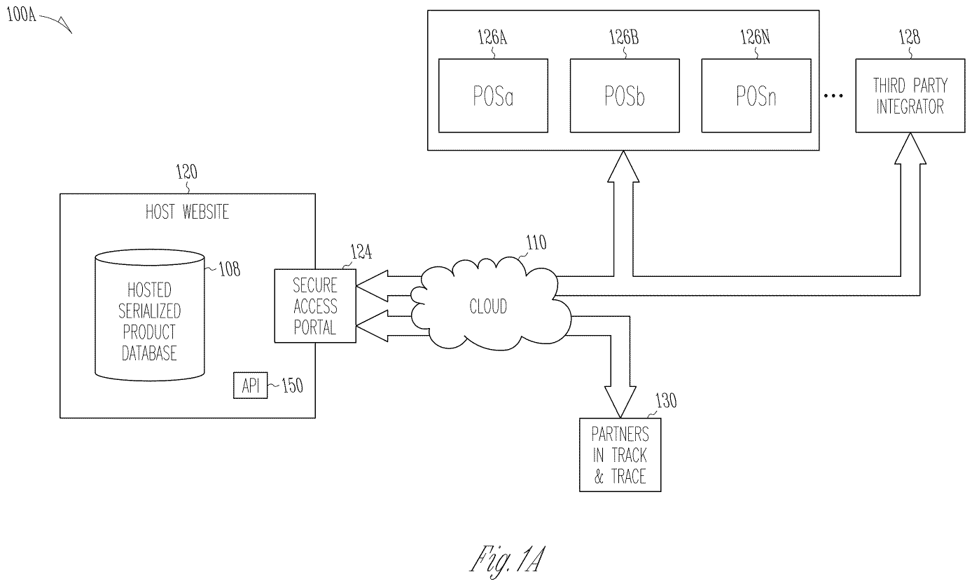

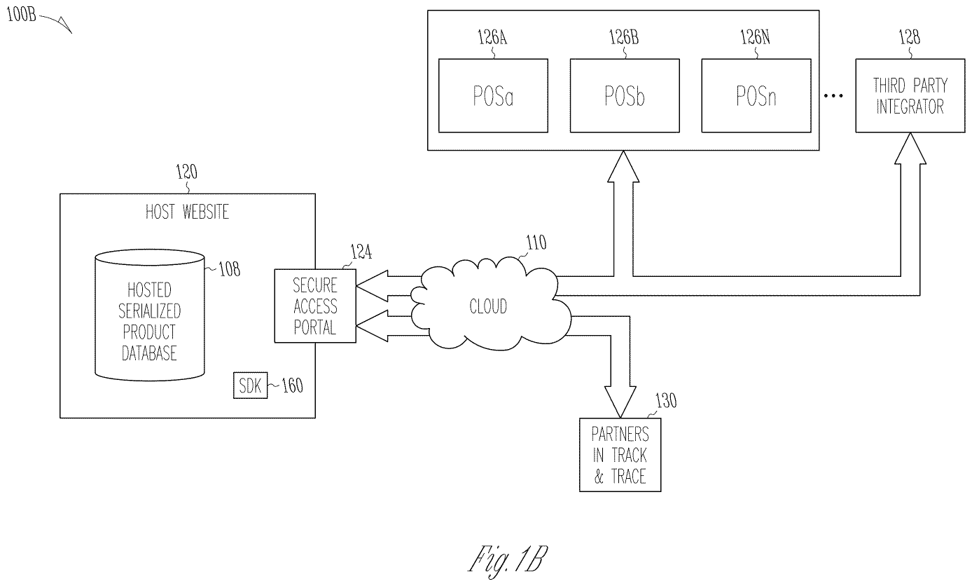

FIG. 1A is a block diagram of various functional modules of a retail identification system having a serialized product database that exchanges information using an application programming interface (API) for software by various partners in the track and trace process and point of sale (POS) systems, according to one embodiment of the present subject matter. FIG. 1A shows an exemplary retail ID system 100A with a hosted serialized product database 108 and host website 120 connected via a secure access portal 124. These components communicate over a network 110, such as the INTERNET cloud 110. Multiple point-of-sale (POS) systems (126a, 126b, 126n) and other interested parties, such as one or more third party integrators (128) communicate with the website 120 via an API 150. The system 100A also allows communications from partners 130 in the track and trace system. Example partners include, but are not limited to growers, processors, distributors, dispensaries, and regulators. The system allows controlled, secure access via secure access portal 124 that gives the partners the ability to communicate information about any aspect of the product. For example, the partners may have information to update the hosted serialized product database on any number of parameters, including, but not limited to information about a batch, a crop, seeds, and/or product-by-product basis.

FIG. 1B is a block diagram of various functional modules of a retail identification system having a serialized product database that exchanges information using a software development kit (SDK) for software by various partners in the track and trace process and point of sale (POS) systems 100B, according to one embodiment of the present subject matter. FIG. 1B shows that a software development kit (SDK 160) is provided to software developers so they can develop their own customized interface to the website 120 and product database 108. Thus, system developers are not restrained to the API examples provided and those skilled in the art can develop their own calls, functions, endpoints, and workflows using SDK 160.

The electronically readable code system creates a plurality of unique readable codes. In various embodiments the codes are QR codes or other printable codes which are electronically readable and which allow the user to create millions of unique electronically readable codes, print or store them on compliant product labels, and encode them with data for supply chain partners as well as consumers. In various embodiments the system creates a database backed electronically readable code system that enables the user to “serialize” an entire packaged goods supply chain. In this way a user can give each individual unit of a product offering its own code and track the manufacturing, distribution, and sales information with a private remote database for every unit of that product offering. The system allows for control of the reading and writing of data for that database to protect the custody of the information for up to each and every unit of the product offering. In various embodiments, the present system creates a registry of these unique identifiers and stores them securely in a database 108. The following examples demonstrate the system using the example of QR codes; however, it is understood that any other electronically readable code may be used including, but not limited to, holographic codes, QR codes, barcodes, and RFID codes.

A code created by this system may generate mobile-compatible links that lead consumers to a mobile app that will help them learn more about the product. The software may provide limited and controlled access to database 108 to provide the ability to update provenance concerning one or more product units, and to read provenance information. A web application manages data read and write permissions for these codes. Software administrators may create permission sets for data reads and data writes on a per user, per organization, per barcode, and per barcode batch basis.

### Case Pack Labeling

Cannabis retailers currently expend countless hours re-labeling individual unit packages and manually entering compliance and point of sale data. The present system allows cannabis manufacturers to assist with labeling and data transfer, but without the entailed labor costs. In various embodiments, the present subject matter establishes partnership opportunities between supply chain trading partners by allowing them to asynchronously pass messages via a QR-backed shared database.

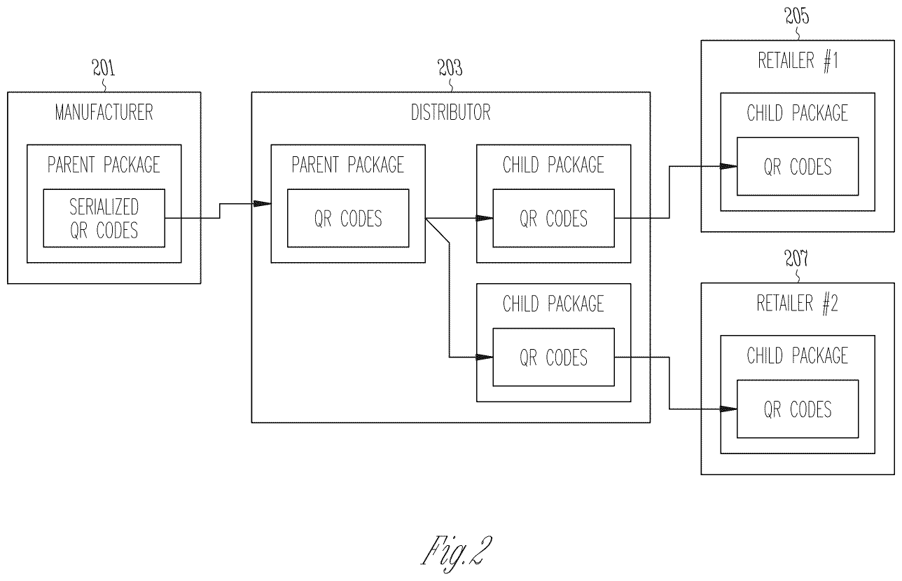

FIG. 2 shows an exemplary labeling schema according to one embodiment of the present subject matter. The manufacturer 201 provides serialized codes (such as a QR code) to a parent package. Distributor 203 can divide the parent package into a plurality of child packages, each having its own unique code (for example, QR codes). Various retailers 205 and 207 receive the various child packages and have access to the code printed on each package to be able to obtain provenance information per product unit and to track sale of each child package.

The product is provided with a series of codes; a unique code for each product unit. Labels with the codes are printed and applied to the individual product units. The unique codes are used to track the shipment and sales of products. These codes can also be used to retrieve and/or update provenance for each individual product unit.

Now that each cannabis product has been uniquely labeled with a specific QR code, a label applied to the case pack makes it easy to use an a QR-scanner to load the comprehensive list of units into inventory management systems, as well as downstream point of sale systems. The present system allows for a “case pack label” that is provided by a barcode labeling system at the time of product labeling. A QR code printed on that label contains information needed to help downstream supply chain partners access the product data contained within the package.

Various embodiments include a Mobile Content Management System (MCMS), which is a web application for creating and managing mobile content linked to the QR code system. The MCMS allows non-technical users to create content that is also data-rich and ready for machine-readable import by downstream Enterprise Resource Planning (ERP) systems, Warehouse Management Systems (WMS), and Point of Sale (PoS) systems.

### Streamlined Inventory Receiving

Product labeling and relabeling incur substantial labor costs in modern retail supply chains. Many retail supply chains require their products to be labeled with a barcode generated by their point-of-sale system to allow the cashier to easily locate the product in the PoS database and complete a sales transaction.

Products that have been labeled with an individual, unique (and potentially serialized) barcode allow the retailer to skip this secondary labeling process by automating inventory receiving and providing the cashier with a manufacturer-applied barcode that can be used at checkout, rather than a time-consuming retailer-applied secondary label.

To achieve this, retailers use the QR codes affixed to the case pack or individual product package to ingest items into the PoS system upon receiving them. Using a compatible PoS system, the retail software fetches the following permissioned data from the system's API:
Product metadata, including all SKU-associated data needed to mark the item for sale, and
A list of all unique identifiers assigned to the manufacturing batch.

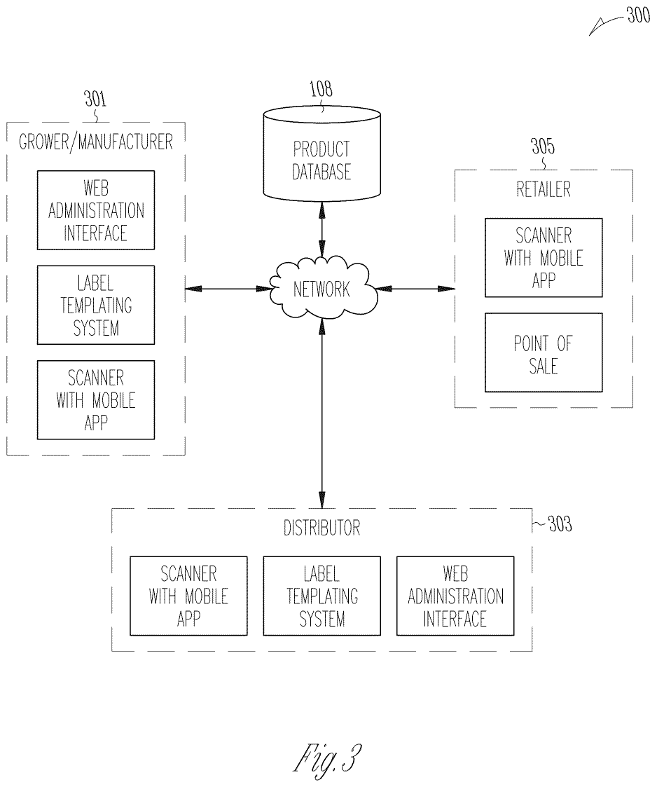

FIG. 3 is a block diagram of various participants in a labeling system 300, according to one embodiment of the present subject matter. The manufacturer (or grower, in the case of plant based products) 301 has a web administration interface and a label templating system to assign specific codes and to generate new codes as needed. These modules communicate with printers (not shown) and a scanner to scan products which have been labeled. The information is stored in the product database 108 which may be hosted on site at the manufacturer 301, or at a remote site, or at multiple sites. The network may be a local network and may include the INTERNET. The distributor 303 can scan product codes as needed to track inventory. The distributor 303 may be able to separate packages containing individual units and to generate new unique codes according to the label templating system so as to identify individual product units and to communicate with database 108. The distributor 303 may also have a web administration interface to communicate with the product database 108, manufacturer 301, and retailer 305. The distributor 303 may have a label templating system and scanner of its own. The retailer has a scanner and point of sale equipment that can be further used to communicate with database 108 for tracing and tracking of individual product units.

At this moment during the inventory receiving process, the retailer has been sent a known quantity of products, but the products'unique identifiers are unknown to the PoS system. The present method prevents manufacturers and distributors from having to invest labor in identifying which UIDs (unique identifiers) are being sent to which retailer out of any given batch. Instead, during inventory the receiving process, the system uses a single UID to alert the PoS system which manufacturing batch the case pack belongs to. The system then returns a complete list of UIDs that belong to the batch. These identifiers are added to a lookup table in the PoS system. After adding any additional needed metadata to the received invoice, the products are then ready to be sold.

Upon checkout, a cashier scans the QR code and references the previously created lookup table. Upon locating a match, the system then completes the checkout process. Finally, the PoS then sends the globally unique identifier to the system's API service to validate that it has been sold.

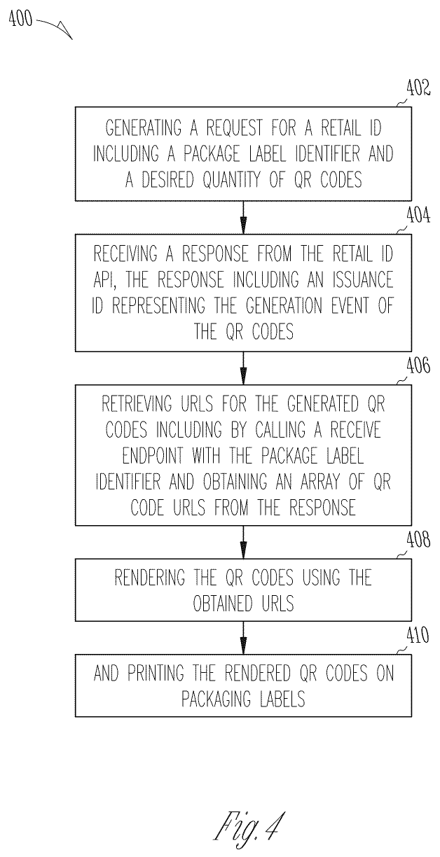

FIG. 4 illustrates an example embodiment of a method for printing labels for products on a per unit basis, according to one embodiment of the present subject matter. One label printing workflow (400) involves generating a request for a Retail ID including a package label identifier and a desired quantity of QR codes (402), receiving a response with an issuance ID representing the generation event of the QR codes (404), retrieving URLs for the generated QR codes (406), rendering the QR codes (408), and printing them on packaging labels (410). In various embodiments, retrieving URLs for the generated QR codes includes calling a receive endpoint with the package label identifier and obtaining an array of QR code URLs from the response. The various steps of the printing process may vary without departing from the scope of the present subject matter.

### API Exemplary Calls and Functions

Some exemplary API calls include GET calls and POST calls.

### Get Calls

A GET call (or GET request) is an HTTP method used to retrieve data from a specified resource. In the Retail ID system, GET calls are used for endpoints that retrieve information without modifying data on the server.

For example, the Receive endpoint uses a GET request: GET /retailid/v2/receive/{label}. This endpoint retrieves information about a package being received, including QR code URLs and sibling package tags, without changing any data on the server.

Similarly, the Receive by QR code endpoint also uses a GET request: GET /retailid/v2/receive/qr/{shortcode}. This endpoint functions similarly to the Receive endpoint but uses a QR code instead of a package label to retrieve package information.

In both cases, the GET call/request is used to fetch data from the server without sending any data in the request body. This is in contrast to POST requests, which are used for endpoints that create or modify data on the server, such as the Generate endpoint for creating QR codes.

### POST Calls

A POST call is an HTTP method used to send data to a server to create or update a resource. In the context of the Retail ID API, POST calls are used for endpoints that create or modify data on the server.

For example, the Generate endpoint uses a POST request to create new QR codes. When making a POST call to this endpoint, the client sends data in the request body, such as the package label and desired quantity of QR codes. The server then processes this data to generate the QR codes and returns a response with an issuance ID.

Other examples of POST calls in the Retail ID API include the Scan and Associate endpoint for associating QR codes with packages, and the Sales endpoints for recording sales transactions. These POST calls allow clients to send data to the server, triggering actions that create or update information in the system.

Unlike GET requests, which are used to retrieve data without modifying server resources, POST calls are designed to submit data to be processed and potentially create new resources on the server.

### Some Exemplary API Endpoints

Some exemplary API endpoints include, but are not limited to, generate, receive, receive by QR code, scan and associate, sales, info and discontinue endpoints

### Generate Endpoint

The Generate API endpoint is part of a process for creating QR codes in the Retail ID system. This process begins with a request to generate QR codes for a specific package. The user sends a POST request to /retailid/v2/generate, including the license number of the printing facility as a parameter. The request body contains the 24-digit package label and the desired quantity of QR codes to generate.

Upon receiving this request, the system processes it and generates the specified number of unique QR codes for the given package. The system then responds with an IssuanceId, which is a unique identifier for this specific QR code generation event. This IssuanceId can be used for tracking or referencing this particular set of generated QR codes in future operations.

After receiving the IssuanceId, the next step in the process typically involves retrieving the actual QR code URLs. This is done using a separate API call to the Receive endpoint, where the package label is provided to obtain an array of URLs for the generated QR codes. These URLs can then be used to render and print the QR codes on packaging labels.

This Generate endpoint is an important part of the label printing workflow, allowing users to create unique identifiers for each unit of a product. It's designed to streamline supply chain operations and simplify the labeling process for database users, supporting the overall goal of tracking products on a per-unit basis throughout the supply chain.

### Receive Endpoint

The Receive endpoint is a GET request to /retailid/v2/receive/{label} that allows users to retrieve information about a package being received. It requires the package label and license number of the receiving facility as parameters. The response includes an array of URLs for all QR codes in the batch, an array of sibling package tags, and a boolean indicating if verification is required. This endpoint is crucial for the inventory receiving process, enabling retailers to obtain QR code information for newly received packages.

### Receive by QR Endpoint

The Receive by QR code endpoint functions similarly to the Receive endpoint but uses a QR code instead of a package label. It is a GET request to /retailid/v2/receive/qr/{shortcode} and requires the QR code and license number as parameters. This endpoint is useful when scanning individual product units rather than package labels, providing flexibility in the receiving process.

### Scan and Associate Endpoint

The Scan and Associate endpoint is a POST request to /retailid/v2/associate that allows users to associate QR codes with specific packages. It requires the license number of the receiving facility and a request body containing the package label and an array of QR code URLs to associate. This endpoint is essential for correcting package associations and managing inventory accuracy.

### Sales Endpoints

The Sales endpoints, such as POST /sales/v2/receipts and POST /sales/v2/deliveries, are used for recording sales transactions. These endpoints have been updated to include QR code information in the transaction data, allowing for more detailed tracking of individual product units sold. This enhancement supports the system's ability to track products on a per-unit basis throughout the supply chain.

### Info Endpoint

The Info endpoint is a POST request to /retailid/v2/packages/info that retrieves detailed information about one or more packages. It requires the license number and an array of package labels in the request body. The response includes data such as QR code count, estimated balance, and whether the package requires verification. This endpoint is valuable for obtaining comprehensive package information quickly.

### Discontinue Endpoint

The Discontinue endpoint is a POST request to /retailid/v2/discontinue used to disassociate QR codes from packages. It requires the license number and an array of package labels in the request body. This endpoint is typically used during testing or in rare cases where QR codes need to be removed from a package. Once discontinued, the QR codes cannot be reactivated.

### Merge Endpoint

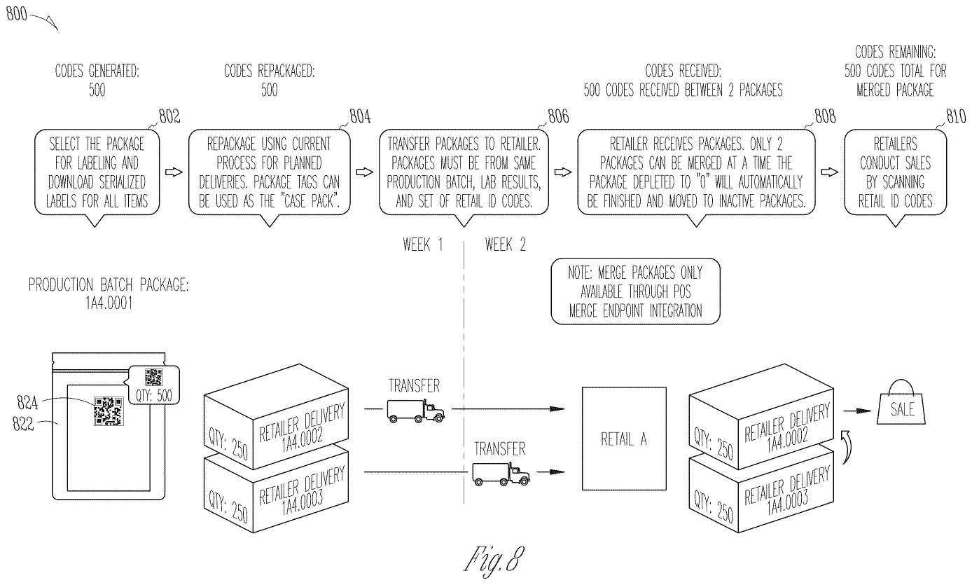

The Merge endpoint provides a process for merging multiple packages using unique codes and the database, as described below with respect to FIG. 8.

These endpoints collectively form a comprehensive API that supports the tracking and management of products throughout the supply chain, from receiving and inventory management to sales and quality control.

### Some Exemplary Point of Sale Workflows

The Retail ID API supports several point of sale workflows. The workflows are designed to streamline inventory management and sales processes while maintaining accurate tracking of individual product units throughout the supply chain. Some exemplary point of sale workflows include, but are not limited to, receiving a licensed transfer, receiving an initial package from a batch, receiving a subsequent package from a batch, correcting a package association, and posting sales.

Receiving a licensed transfer involves the retailer logging into the user interface to receive an incoming transfer. The API allows integrators to reference the incoming transfers endpoint to get a list of scheduled transfers by ID and manifest number. The package deliveries endpoint can be used to see the specific uniquely marked packages arriving in the transfer.

Receiving an initial package from a batch can be done without scanning individual items. The retailer scans or inputs the package tag, and the POS system calls the Receive endpoint with the package label and facility license number. This returns a list of QR codes for units in the batch and any sibling package tags. For an initial package, there should only be one sibling tag listed.

Receiving a subsequent package from a batch requires scanning each unit QR code if multiple sibling tags are returned by the Receive endpoint. The POS system should direct the user to scan and associate each unit with the package, either in the website directly or through the POS using the Scan and Associate endpoint.

Correcting a package association can be done by using the Scan and Associate endpoint to re-associate QR codes with the correct package after the transfer has been received. The Discontinue endpoint can be used to disassociate QR codes without re-association, though this is rare.

Posting sales involves using the existing Sales endpoints, now updated to include QR codes of units sold within the Transactions array. This allows for proper association of units from the initial received package.

### Some Error Handling Features

The Retail ID API incorporates several error handling features to manage various error scenarios:
Status codes: The API uses standard HTTP status codes to indicate the success or failure of requests. For example, a status code “200” is returned for successful GET calls, while “201” is returned for successful POST calls. This allows developers to quickly identify if a request was processed correctly.
Error codes: When an error occurs, the API returns specific error codes along with descriptive messages. For instance, passing an invalid or unauthorized license number results in a 401 error code, while an invalid ID or incorrect URL leads to a 404 error code. These codes help pinpoint the exact nature of the error.
Warnings: Some API responses include a “Warnings” field that provides additional information about potential issues encountered during the request processing. This allows for more nuanced error reporting beyond simple success/failure indicators.
Error fields: In responses like the Info endpoint, there's a dedicated “error” field for each package. This field contains any issues encountered while retrieving the package information, or null if there were none, allowing for package-specific error reporting.
Validation: The API likely performs input validation on requests, though this is not explicitly stated in the provided documents. This would help prevent errors caused by malformed or invalid input data.
Documentation: The API guide provides detailed information on expected request and response formats, helping developers avoid errors due to incorrect implementation.

To handle these errors, developers should implement appropriate error checking and handling in their code, such as checking status codes, parsing error messages, and implementing retry logic where appropriate. The API documentation recommends reviewing the Server Responses section for a comprehensive understanding of possible status codes and their meanings.

Further information can be found in Appendix A (Metrc Retail ID API Guide) and Appendix B (Metrc Retail ID User Guide) of U.S. Provisional Patent Application Ser. No. 63/711,039, each of which is also incorporated by reference in its entirety.

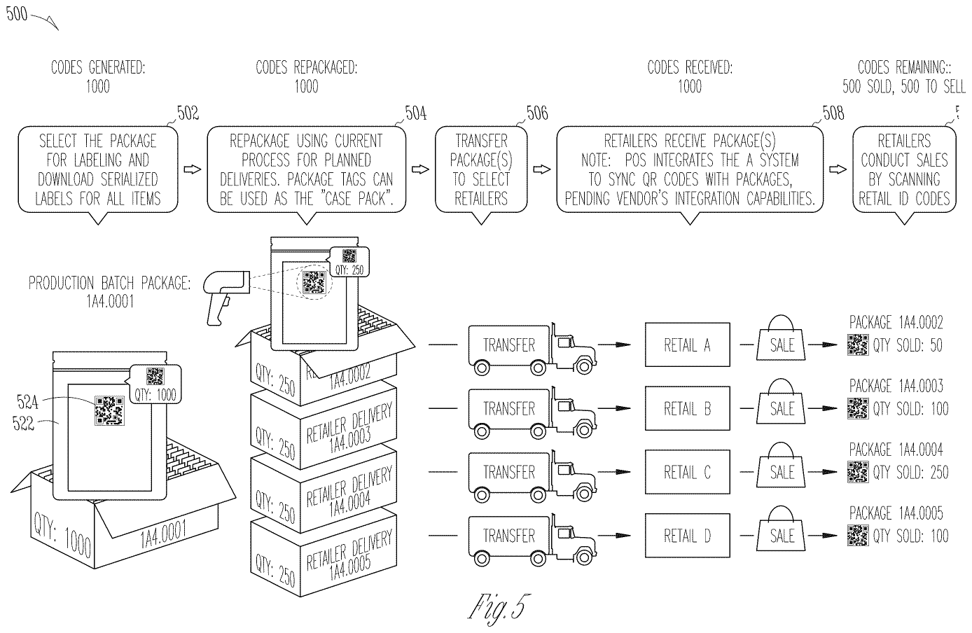

FIG. 5 demonstrates an association of codes to packages, according to one embodiment of the present subject matter. The process (500) begins when a package for labeling is selected and serialized labels are downloaded for all items (502). In the example shown, each product unit 522 is provided a unique ID code 524. In various embodiments, as shown, the code is a QR code. Other codes may be used without departing from the scope of the present subject matter. A Production Batch Package 1a4.0001 with a quantity of 1000 is therefore provided. The system repackages items using the process for planned deliveries (504). Package tags can be used as the “Case Pack”. This step shows the original package of 1000 units being divided into four smaller packages (1a4.0002, 1a4.0003, 1a4.0004, and 1a4.0005), each containing 250 units. The code of each individual unit can be scanned to associate it with a specific delivery package. These packages are then transferred to select retailers, as indicated by the transfer trucks in the diagram (506). Retailers scan the packages to receive them and thereby associate them in the website (508), and may save this information in a product database. The POS integrates with the website to sync QR codes with packages in the product database, pending the vendor's integration capabilities. The retailers conduct sales by scanning Retail ID codes (510). FIG. 5 shows the sales status for each package: Package 1a4.0002 has 50 units sold, 1a4.0003 has 100 sold, 1a4.0004 has all 250 sold, and 1a4.0005 has 100 sold. FIG. 5 also includes a summary of the codes at each stage: 1000 codes were initially generated (502), 1000 were repackaged (504), 1000 were received (508), and of the remaining codes, 500 have been sold and 500 are left to sell (510).

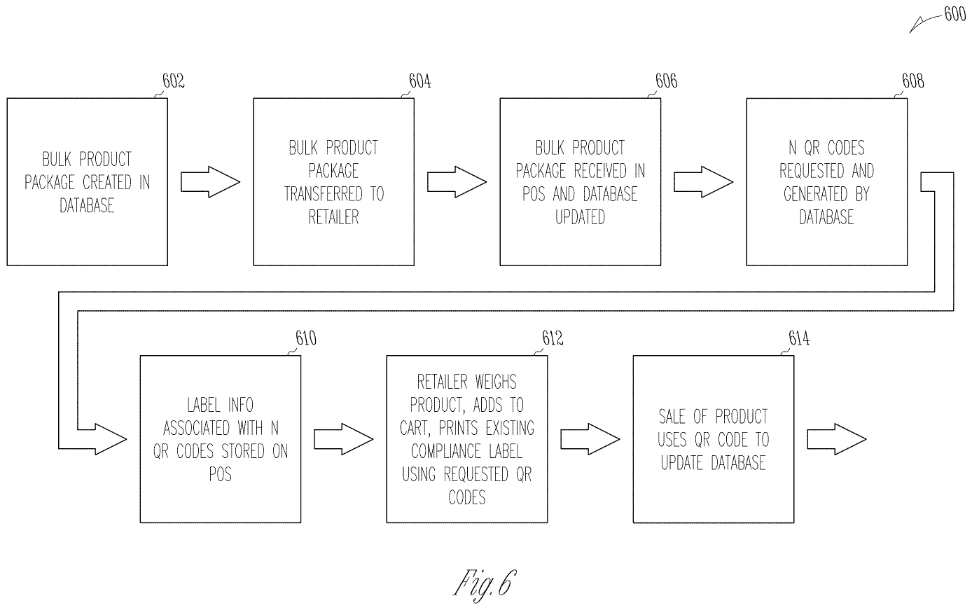

FIG. 6 is a flow chart of label generation for “deli” style product sales, according to one embodiment of the present subject matter. The process 600 of FIG. 6 demonstrates the “deli” style product identification using Retail ID QR codes. This workflow begins with the creation of a bulk product package in the database (602). The package is then transferred to the retailer (604), where it is received in the Point of Sale (POS) system and the database is updated (606). Next, a specified number (n) of QR codes are requested and generated by the database (608). The label information associated with these n QR codes is then stored on the POS system (610). When a sale occurs, the retailer weighs the product, adds it to the cart, and prints an existing compliance label using the requested QR codes (612). A sale of the product results in use of the QR code to update the database (614). The POS partner can request as many “deli codes” (n codes) for the bulk package as needed, providing flexibility in the system.

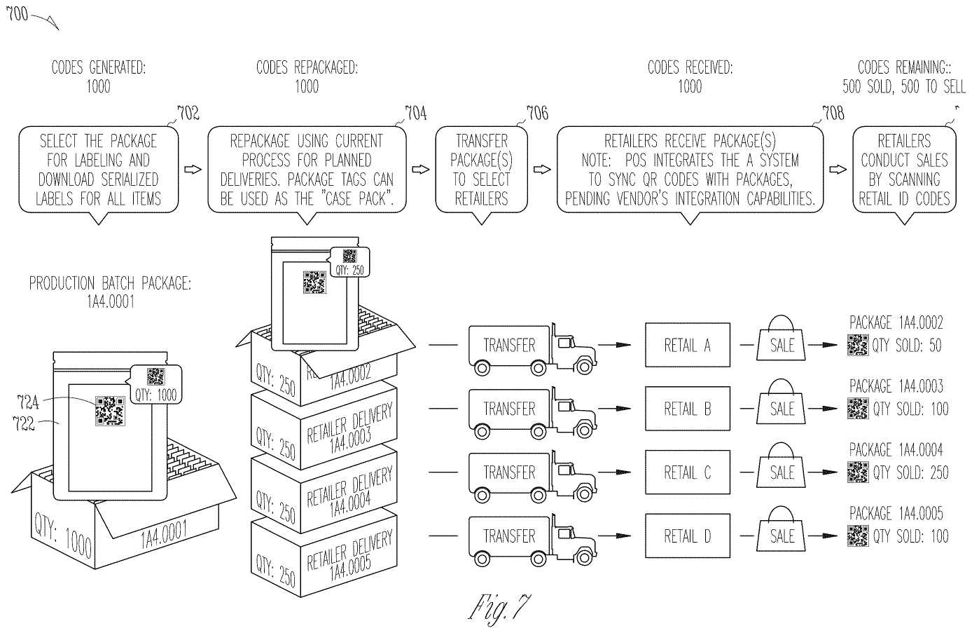

FIG. 7 demonstrates package handling and labelling using unique codes and the serialized product database, according to one embodiment of the present subject matter. The package handling process (700) includes a package for labeling is selected and serialized labels are downloaded for all items (702). In the example shown, each product unit 722 is provided a unique ID code 724. This provides a Production Batch package 1a4.0001 with a quantity of 1000. The system repackages items using the process for planned deliveries (704). Package tags can be used as the “Case Pack”. This step shows the original package being divided into four smaller packages (1a4.0002, 1a4.0003, 1a4.0004, and 1a4.0005), each containing 250 units. These packages are then transferred to select retailers, as indicated by the transfer trucks in the diagram (706). Retailers scan the packages to receive them and thereby associate them in the website (708), storing that information in the product database. The POS integrates with the website to sync QR codes with packages, pending the vendor's integration capabilities. The retailers conduct sales by scanning Retail ID codes (710). FIG. 7 shows the sales status for each package: Package 1a4.0002 has 50 units sold, 1a4.0003 has 100 sold, 1a4.0004 has all 250 sold, and 1a4.0005 has 100 sold.

FIG. 7 also includes a summary of the codes at each stage: 1000 codes were initially generated (702), 1000 were repackaged (704), 1000 were received (708), and of the remaining codes, 500 have been sold and 500 are left to sell (710).

FIG. 8 demonstrates a process of merging two packages using unique codes and the serialized product database, according to one embodiment of the present subject matter. The Merge Package QR Flow (800) is shown for two packages from the same source package arriving at the same retail location. The package for labeling is selected and serialized labels are downloaded for all items (802). In the example shown, each product unit 822 is provided a unique ID code 824. This is represented by the Production Batch Package 1a4.0001 with a quantity of 500. The process for planned deliveries is used to repackage the items (804). Package tags can be used as the “Case Pack”. This step shows the original package being divided into two smaller packages (1a4.0002 and 1a4.0003), each containing 250 units. These packages are transferred to the retailer (806). The packages must be from the same Production Batch, Lab Results, and set of Retail ID codes. The retailer scans the packages to receive them and associate them in the website (808). In various embodiments, only 2 packages can be merged at a time. The package depleted to ‘0’ will automatically be finished and moved to Inactive Packages. Merge Packages are available through POS Merge endpoint integration. Retailers conduct sales by scanning Retail ID codes (810).

FIG. 8 includes a summary of the codes at each stage: 500 codes were initially generated (802), 500 were repackaged (804), 500 codes were received between 2 packages (808), and 500 codes total remain for the merged package (810).

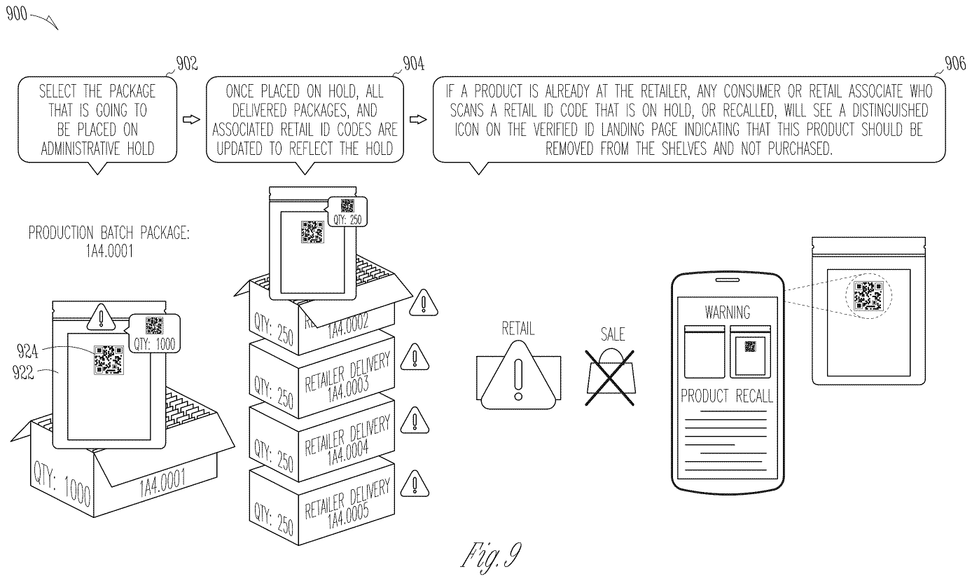

FIG. 9 demonstrates a process for administrative holds and recalls of product using unique codes and the serialized product database (900), according to one embodiment of the present subject matter. It allows state users to place holds and recalls on packages, notify consumers accordingly, and develop an administrative interface for managing these holds and recalls. A state regulatory user selects the package that is to be placed on administrative hold using the website (902), so the product database is updated with the most current information for each product. This is represented by the Production Batch Package 1a4.0001 with a quantity of 1000 units. Once placed on hold, all derived packages and associated Retail ID codes are updated to reflect the hold status (904). This is visually depicted by warning symbols on the parent package and its derived packages (1a4.0002, 1a4.0003, 1a4.0004, and 1a4.0005). If a product is already at the retailer, any consumer or retail associate who scans a Retail ID code that is on hold or recalled will see a distinguished icon on the system VerifID landing page (906). This icon indicates that the product should be removed from the shelves and not purchased. The figure shows this with a “Retail” storefront icon and a crossed-out “Sale” icon, along with a product recall notice on a mobile device.

The system will allow state users to place holds and recalls on packages, notifying consumers accordingly, and develops an admin interface for managing these holds and recalls. This process ensures that potentially problematic products can be quickly identified and removed from the supply chain, enhancing consumer safety and regulatory compliance.

### Features to Combat Diversion and Inversion

The present system is configurable to combat diversion and inversion using unique codes and the serialized product database, according to various embodiments of the present subject matter. The following examples are provided for the case of the product being cannabis, however, it is understood that other products may benefit from the present subject matter and the disclosure is not intended to be limited to cannabis.

Diversion: Diversion involves legal cannabis being redirected from the regulated market into the illegal market. This can occur at various points in the supply chain, such as cultivation, manufacturing, or retail. By scanning the QR code, retailers, distributors, and consumers can see details like testing results, origin, and packaging dates. This makes it harder for participants in the supply chain to misreport or misrepresent the amount of product they possess. Knowing that every unit is traceable increases accountability. Consumers can also scan QR codes to verify the origin of the product they are purchasing. This increases consumer trust and reduces the market demand for diverted or unregulated products.

Inversion: Inversion is the act of introducing illegal cannabis products into the legal supply chain. This can happen when unlicensed growers or producers sell cannabis to licensed businesses, which then attempt to pass it off as part of their legally sourced inventory. Each QR code is unique and linked to a specific batch of cannabis, recording its entire journey from seed to sale. This includes cultivation, harvesting, processing, and retail. When a product is scanned, it reveals its origin, history, and testing results. Because each product's details are tied to a verified origin within the legal supply chain, it becomes harder for illegal cannabis to be passed off as legal. Discrepancies between a QR code and a product's registered details would raise red flags, helping regulators detect inversion attempts.

In various embodiments, the present subject matter can be combined with other technologies to combat inversion and diversion, such as geolocation as a metric for corroborating proper distribution and sales. Other technologies can be employed as well, including, but not limited to passive and active RFID tagging of containers. In various embodiments, the present system uses unique codes to create a proof of purchase of a product and/or proof of disposal of a product in order to combat diversion and inversion.

### Anti-Counterfeit Protection

The process of associating globally unique identifiers to products within a supply chain also provides strong protection against counterfeits. One way anti-counterfeit protection is enabled is by registering a GPS-located data point with every consumer QR scan. The system uses a statistical risk analysis model to determine the risk of a given product being counterfeit. Because each product is uniquely identified via serialized QR, and these QR values are not predictable, product counterfeiters have only two options:
1) Not include a QR code on the counterfeit product.
2) Attempt to copy a QR code already in existence.

If consumers can be educated to expect a QR code that links to an authorized mobile experience on their products, the absence of a QR code will serve as anti-counterfeit protection.

If the counterfeiter attempts to copy a code already in existence, the system will prevent that code from functioning after detecting multiple scans of a product from disparate geographic locations. Once the statistical model determines that a code has been copied and is causing a single unique code to trigger scans from various locations, the system flags the product as counterfeit. The consumer will optionally be notified of this counterfeit determination via the mobile content linked to the QR.

In various embodiments, the present subject matter can be combined with other technologies to combat counterfeiting, such as using unique codes to create a proof of purchase of a product and/or proof of disposal of a product.

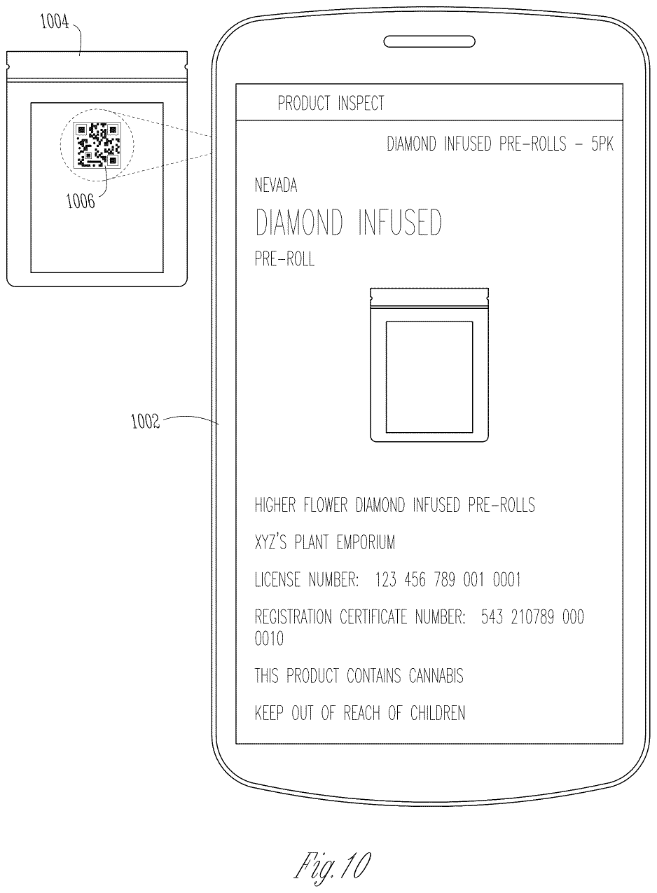

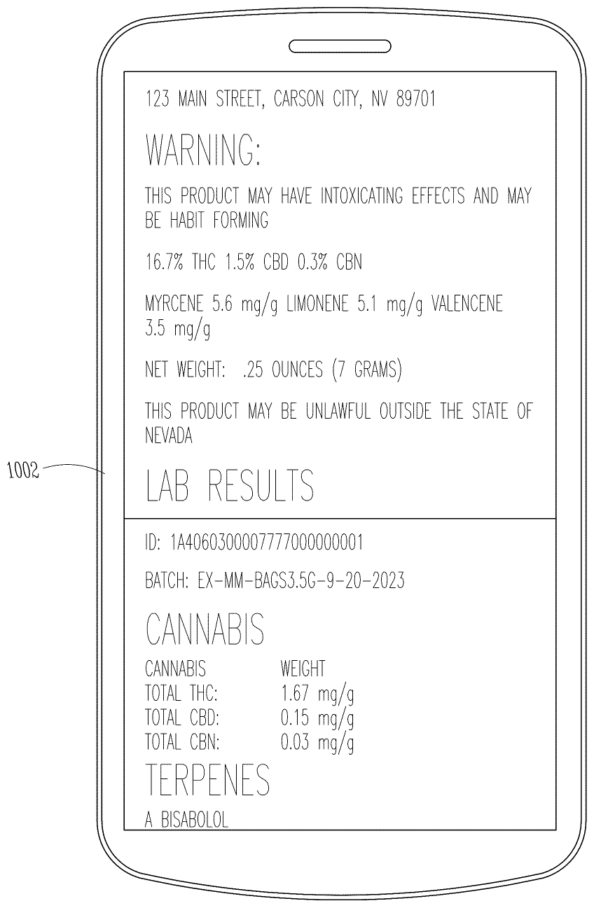

FIGS. 10 and 11 demonstrate a mobile inspection application that can be used during inspections using unique codes and the serialized product database, according to one embodiment of the present subject matter. In the example shown in FIGS. 10 and 11, a mobile phone 1002 executes an application which can operate the camera of the mobile phone to scan the unique code 1006 of a unit 1004. Other devices and codes may be used, and the application is not limited to operations on a mobile phone or to use of a QR code as the unique code.

In various embodiments, the mobile inspection application is designed to facilitate product inspection and verification using integrated QR code scanning. The mobile inspection app provides integrated QR code scanning, which allows inspectors to scan QR codes on products to retrieve key information, including:

### Source Uid (unique Identifier),

product description,
originating licensed premises where the item was created or sourced from, and
a tab for accessing the Certificate of Analysis (CoA).

The mobile inspection application also provides parameters, including, but not limited to, for each scanned product:
UID,
quantity,
manifest number for the transfer of the items,
expiration date, and
date the product was shipped to the retailer location.

The user interface of the mobile inspection application displays a scanned product's details. The screen includes information such as the product name (for example, “Diamond Infused”), lab results, and cannabinoid content. This visual representation demonstrates how the app presents the scanned information in a clear, user-friendly format.

This mobile application may be uses by regulators, retailers, or other stakeholders in the supply chain to quickly verify product information, track its movement, and ensure compliance with regulations. By integrating QR code scanning with detailed product information, the app streamlines the inspection process and enhances supply chain transparency.

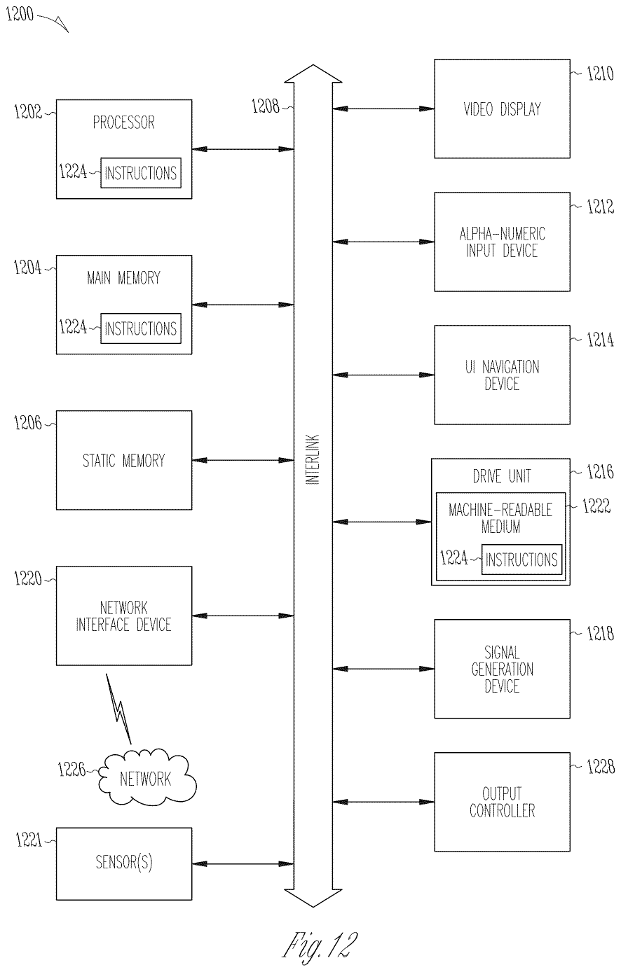

FIG. 12 illustrates a block diagram of an example machine 1200 upon which any one or more of the techniques (e.g., methodologies) discussed herein may perform. For example, any of the devices of the network based systems, computers, databases, routers, switches, scanners, printers, wireless communications, network communications, and/or mobile phones discussed herein may include processing electronics and communication electronics as exemplified in one or more variations of the exemplary electronics of FIG. 12.

In various embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environment. The machine 1200 may be configured to perform the methods of the present disclosure. The machine 1200 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1200 may include a hardware processor 1202 (e.g., a central processing unit (CPU), a graphics processing unit (GPU), a hardware processor core, or any combination thereof), a controller, a microcontroller, a microprocessor, a main memory 1204 and a static memory 1206, some or all of which may communicate with each other via an interlink (e.g., bus) 1208. The machine 1200 may further include a display unit 1210, an alphanumeric input device 1212 (e.g., a keyboard), and a user interface (UI) navigation device 1214 (e.g., a mouse). In an example, the display unit 1210, input device 1212 and UI navigation device 1214 may be a touch screen display. The machine 1200 may additionally include a storage device (e.g., drive unit) 1216, a signal generation device 1218 (e.g., a speaker), a network interface device 1220, and one or more sensors 1221, such as a global positioning system (GPS) sensor, compass, accelerometer, or other sensor. The machine 1200 may include an output controller 1228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within static memory 1206, or within the hardware processor 1202 during execution thereof by the machine 1200. In an example, one or any combination of the hardware processor 1202, the main memory 1204, the static memory 1206, or the storage device 1216 may constitute machine readable media.

While the machine readable medium 1222 is illustrated as a single medium, the term “machine readable medium” may include a single medium or multiple media (e.g., a centralized or distributed database, and/or associated caches and servers) configured to store the one or more instructions 1224.

The term “machine readable medium” may include any medium that is capable of storing, encoding, or carrying instructions for execution by the machine 1200 and that cause the machine 1200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 1224 may further be transmitted or received over a communications network 1226 using a transmission medium via the network interface device 1220. Machine 1200 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, Zigbee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 1220 may include one or more physical jacks (e.g., Ethernet, coaxial, or phone jacks) or one or more antennas to connect to the communications network 1226. In an example, the network interface device 1220 may include a plurality of antennas to wirelessly communicate using at least one of single-input multiple-output (SIMO), multiple-input multiple-output (MIMO), or multiple-input single-output (MISO) techniques. In some examples, the network interface device 1220 may wirelessly communicate using Multiple User MIMO techniques.

### Examples

The following examples are only some of the examples that can be provided by the present subject matter.

Example 1: A method for enhanced package merging of cannabis products using unique QR codes, including: generating a plurality of unique QR codes; associating each unique QR code with an individual cannabis product unit in a centralized database; applying the unique QR codes to labels on the individual cannabis product units; packaging a first subset of the individual cannabis product units into a first package; packaging a second subset of the individual cannabis product units into a second package; transferring the first and second packages to a retail location; receiving scanned unique QR codes on the individual cannabis product units in the first and second packages at the retail location; associating the first and second packages as a single merged package based on the scanned unique QR codes; and updating the centralized database to reflect the merging of the first and second packages.

Example 2: The method of Example 1, further including storing in the centralized database information related to at least one of: safety testing results, cannabis strain genetics, or reported adverse reactions for the cannabis product units.

Example 3: The method of Example 1 or 2, wherein the unique QR codes encode information including a package identifier, batch identifier, and product identifier.

Example 4: The method of any one of Examples 1-3, further including verifying that the first and second packages are from the same production batch prior to merging.

Example 5: The method of any one of Examples 1-4, wherein merging the packages includes associating all unique QR codes from the first and second packages with the merged package in the centralized database.

Example 6: The method of any one of Examples 1-5, further including generating a new unique identifier for the merged package.

Example 7: The method of any one of Examples 1-6, wherein scanning the unique QR codes is performed using a mobile device running a dedicated scanning application.

Example 8: The method of any one of Examples 1-7, further including restricting the merging to a maximum of two packages at a time.

Example 9: A method for accounting for deli-style cannabis sales using dynamically generated codes, including: creating a bulk cannabis product package in a centralized database; transferring the bulk cannabis product package to a retailer; receiving the bulk cannabis product package into a point-of-sale (POS) system at the retailer; requesting a plurality of unique QR codes from the centralized database for the bulk cannabis product package; generating the plurality of unique QR codes; storing label information associated with the plurality of unique QR codes in the POS system; weighing a portion of the bulk cannabis product for a sale; selecting an unused unique QR code from the plurality of unique QR codes; generating parameters of a compliance label for the weighed portion using the selected unique QR code; and updating the centralized database to reflect the sale using the selected unique QR code.

Example 10: The method of Example 9, further including storing in the centralized database information related to at least one of: cannabis potency, terpene profile, or harvest date for the bulk cannabis product.

Example 11: The method of Example 9 or 10, wherein the unique QR codes are generated on-demand as needed for sales.

Example 12: The method of any one of Examples 9-11, further including associating each unique QR code with a specific weight of cannabis product.

Example 13: The method of any one of Examples 9-12, wherein updating the database includes recording a weight of cannabis product sold and the associated unique QR code.

Example 14: The method of any one of Examples 9-13, further including tracking remaining inventory of the bulk cannabis product package based on the unused unique QR codes.

Example 15: The method of any one of Examples 9-14, wherein the compliance label includes product information retrieved from the centralized database based on the selected unique QR code.

Example 16: The method of any one of Examples 9-15, further including verifying that each unique QR code is used only once.

Example 17: A method for enhancing cannabis product tracking and reducing labeling costs, including: generating a plurality of unique QR codes for a batch of cannabis products; associating each unique QR code with an individual cannabis product unit in a centralized database; applying labels with the unique QR codes to the individual cannabis product units during initial packaging by a manufacturer; transferring the labeled cannabis product units to a distributor; scanning the unique QR codes at the distributor to update product location in the centralized database; transferring the labeled cannabis product units to a retailer; receiving the labeled cannabis product units at the retailer by scanning the unique QR codes; automatically importing product information into a point-of-sale system at the retailer based on the scanned unique QR codes; and selling the cannabis product units using original manufacturer-applied labels, thereby eliminating a need for retailer re-labeling.

Example 18: The method of Example 17, further including providing consumers access to information stored in the centralized database about the cannabis product units via the unique QR codes, including at least one of: cannabinoid profile, cultivation method, or quality control test results.

Example 19: The method of Example 17 or 18, wherein the unique QR codes encode information including a product identifier, batch number, and packaging date.

Example 20: The method of any one of Examples 17-19, further including using the unique QR codes to verify cannabis product authenticity throughout a supply chain.

Example 21: The method of any one of Examples 17-20, wherein automatically importing product information includes retrieving product details, pricing, and inventory data from the centralized database.

Example 22: The method of any one of Examples 17-21, further including updating the centralized database in real-time as cannabis products are sold using the unique QR codes.

Example 23: The method of any one of Examples 17-22, wherein the unique QR codes are used to facilitate cannabis product recalls by quickly identifying affected units across multiple retail locations.

Example 24: The method of any one of Examples 17-23, further including using the unique QR codes to provide consumers with detailed cannabis product information by scanning the code with a mobile device.

Example 25: A system for tracking cannabis products using unique QR codes, the system including: a processor; a memory storing machine readable instructions that, when executed by the processor, cause the system to: generate a plurality of unique QR codes; associate each unique QR code with an individual cannabis product unit in a centralized database; apply the unique QR codes to labels on the individual cannabis product units; receive scanned unique QR codes from the individual cannabis product units at different points in a supply chain; update location information for the individual cannabis product units in the centralized database based on the received scanned unique QR codes; and provide access to the updated location information in the centralized database to authorized users.

Example 26: The system of Example 25, wherein the machine readable instructions further cause the system to store in the centralized database information related to at least one of: safety testing results, cannabis strain genetics, or reported adverse reactions for the cannabis product units.

Example 27: The system of Example 25 or 26, wherein the unique QR codes encode information including a package identifier, batch identifier, and product identifier.

Example 28: The system of any one of Examples 25-27, wherein the machine readable instructions further cause the system to verify that packages of cannabis product units are from the same production batch prior to allowing merging of the packages.

Example 29: The system of any one of Examples 25-28, wherein the machine readable instructions further cause the system to generate a new unique identifier for merged packages of cannabis product units.

Example 30: The system of any one of Examples 25-29, wherein the machine readable instructions further cause the system to restrict merging of packages to a maximum of two packages at a time.

Example 31: The system of any one of Examples 25-30, wherein the machine readable instructions further cause the system to generate on-demand unique QR codes for deli-style cannabis sales.

Example 32: The system of any one of Examples 25-31, wherein the machine readable instructions further cause the system to associate each unique QR code with a specific weight of cannabis product for deli-style sales.

Example 33: The system of any one of Examples 25-32, wherein the machine readable instructions further cause the system to track remaining inventory of bulk cannabis product packages based on unused unique QR codes.

Example 34: The system of any one of Examples 25-33, wherein the machine readable instructions further cause the system to automatically import product information into point-of-sale systems at retailers based on scanned unique QR codes.

Example 35: The system of any one of Examples 25-34, wherein the machine readable instructions further cause the system to facilitate cannabis product recalls by identifying affected units across multiple retail locations using the unique QR codes.

Example 36 is at least one machine-readable medium including instructions that, when executed by processing circuitry, cause the processing circuitry to perform operations to implement of any of Examples 1-35.

Example 37 is an apparatus comprising means to implement of any of Examples 1-36.

Example 38 is a system to implement of any of Examples 1-37.

Example 39 is a method to implement of any of Examples 1-38.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A method for enhanced package merging of cannabis products using unique QR codes, comprising:
generating a plurality of unique QR codes;
associating each unique QR code with an individual cannabis product unit in a centralized database;
applying the unique QR codes to labels on the individual cannabis product units;
packaging a first subset of the individual cannabis product units into a first package;
packaging a second subset of the individual cannabis product units into a second package;
transferring the first and second packages to a retail location;
receiving scanned unique QR codes on the individual cannabis product units in the first and second packages at the retail location;
associating the first and second packages as a single merged package based on the scanned unique QR codes; and
updating the centralized database to reflect the merging of the first and second packages.

2. The method of claim 1, further comprising:
storing, in the centralized database, information related to at least one of: safety testing results, cannabis strain genetics, or reported adverse reactions for the cannabis product units.

3. The method of claim 1, wherein the unique QR codes encode information including a package identifier, batch identifier, and product identifier.

4. The method of claim 1, further comprising verifying that the first and second packages are from a same production batch prior to merging.

5. The method of claim 1, wherein merging the packages comprises associating all unique QR codes from the first and second packages with the merged package in the centralized database.

6. The method of claim 1, further comprising generating a new unique identifier for the merged package.

7. The method of claim 1, wherein scanning the unique QR codes is performed using a mobile device running a dedicated scanning application.

8. The method of claim 1, further comprising restricting the merging to a maximum of two packages at a time.

9. A method for accounting for deli-style cannabis sales using dynamically generated codes, comprising:
creating a bulk cannabis product package in a centralized database;
transferring the bulk cannabis product package to a retailer;
receiving the bulk cannabis product package into a point-of-sale (POS) system at the retailer;
requesting a plurality of unique QR codes from the centralized database for the bulk cannabis product package;
generating the plurality of unique QR codes;
storing label information associated with the plurality of unique QR codes in the POS system;
weighing a portion of the bulk cannabis product for a sale;
selecting an unused unique QR code from the plurality of unique QR codes;
generating parameters of a compliance label for the weighed portion using the selected unique QR code; and
updating the centralized database to reflect the sale using the selected unique QR code.

10. The method of claim 9, further comprising:
storing in the centralized database information related to at least one of: cannabis potency, terpene profile, or harvest date for the bulk cannabis product.

11. The method of claim 9, wherein the unique QR codes are generated on-demand as needed for sales.

12. The method of claim 9, further comprising associating each unique QR code with a specific weight of cannabis product.

13. The method of claim 9, wherein updating the database comprises recording a weight of cannabis product sold and the associated unique QR code.

14. The method of claim 9, further comprising tracking remaining inventory of the bulk cannabis product package based on the unused unique QR codes.

15. The method of claim 9, wherein the compliance label includes product information retrieved from the centralized database based on the selected unique QR code.

16. The method of claim 9, further comprising verifying that each unique QR code is used only once.

17. A method for enhancing cannabis product tracking and reducing labeling costs, comprising:
generating a plurality of unique QR codes for a batch of cannabis products;
associating each unique QR code with an individual cannabis product unit in a centralized database;
applying labels with the unique QR codes to the individual cannabis product units during initial packaging by a manufacturer;
transferring the labeled cannabis product units to a distributor;
scanning the unique QR codes at the distributor to update product location in the centralized database;
transferring the labeled cannabis product units to a retailer;
receiving the labeled cannabis product units at the retailer by scanning the unique QR codes;
automatically importing product information into a point-of-sale system at the retailer based on the scanned unique QR codes; and
selling the cannabis product units using original manufacturer-applied labels, thereby eliminating a need for retailer re-labeling.

18. The method of claim 17, further comprising:
providing consumers access to information stored in the centralized database about the cannabis product units via the unique QR codes, including at least one of: cannabinoid profile, cultivation method, or quality control test results.

19. The method of claim 17, wherein the unique QR codes encode information including a product identifier, batch number, and packaging date.

20. The method of claim 17, further comprising using the unique QR codes to verify cannabis product authenticity throughout a supply chain.

21. The method of claim 17, wherein automatically importing product information comprises retrieving product details, pricing, and inventory data from the centralized database.

22. The method of claim 17, further comprising updating the centralized database in real-time as cannabis products are sold using the unique QR codes.

23. The method of claim 17, wherein the unique QR codes are used to facilitate cannabis product recalls by quickly identifying affected units across multiple retail locations.

24. The method of claim 17, further comprising using the unique QR codes to provide consumers with detailed cannabis product information by scanning the code with a mobile device.

25. A system for tracking cannabis products using unique QR codes, the system including:
a processor;
a memory storing machine readable instructions that, when executed by the processor, cause the system to:
generate a plurality of unique QR codes;
associate each unique QR code with an individual cannabis product unit in a centralized database;
apply the unique QR codes to labels on the individual cannabis product units;
receive scanned unique QR codes from the individual cannabis product units at different points in a supply chain;
update location information for the individual cannabis product units in the centralized database based on the received scanned unique QR codes; and
provide access to the updated location information in the centralized database to authorized users.

26. The system of claim 25, wherein the machine readable instructions further cause the system to store in the centralized database information related to at least one of: safety testing results, cannabis strain genetics, or reported adverse reactions for the cannabis product units.

27. The system of claim 25, wherein the unique QR codes encode information including a package identifier, batch identifier, and product identifier.

28. The system of claim 25, wherein the machine readable instructions further cause the system to verify that packages of cannabis product units are from a same production batch prior to allowing merging of the packages.

29. The system of claim 25, wherein the machine readable instructions further cause the system to generate a new unique identifier for merged packages of cannabis product units.

30. The system of claim 25, wherein the machine readable instructions further cause the system to restrict merging of packages to a maximum of two packages at a time.

31. The system of claim 25, wherein the machine readable instructions further cause the system to generate on-demand unique QR codes for deli-style cannabis sales.

32. The system of claim 25, wherein the machine readable instructions further cause the system to associate each unique QR code with a specific weight of cannabis product for deli-style sales.

33. The system of claim 25, wherein the machine readable instructions further cause the system to track remaining inventory of bulk cannabis product packages based on unused unique QR codes.

34. The system of claim 25, wherein the machine readable instructions further cause the system to automatically import product information into point-of-sale systems at retailers based on scanned unique QR codes.

35. The system of claim 25, wherein the machine readable instructions further cause the system to facilitate cannabis product recalls by identifying affected units across multiple retail locations using the unique QR codes.
